(19) United States
(12) Patent Application Publication
(10) Pub. No.: US 2003/0033346 A1
(43) Pub. Date: Feb. 13, 2003

(54) Method, system, and program for managing multiple resources in a system

(75) Inventors: Mark A. Carlson, Boulder, CO (US); Rowan E. da Silva, Tewksbury, MA (US)

Correspondence Address: David W. Victor, KONRAD RAYNES & VICTOR LLP, Suite 210, 315 S. Beverly Drive, Beverly Hills, CA, 90212, US

(73) Assignee: Sun Microsystems, Inc.

(21) Appl. No.: 09/927,985

(22) Filed: Aug. 10, 2001

(51) Int. Cl. G06F 9/00

(52) U.S. Cl. 709/104; 709/223

(57) ABSTRACT

Provided is a method, system, and program for managing multiple resources in a system. A user request for an operation is received that requires performing separate element operations with respect to multiple resources in the system. In response to the user request, commands are communicated to multiple elements, wherein each element is capable of managing one of the resources in the system. For each element receiving at least one of the communicated commands, the element interprets the received commands and performs the element operation requested by the received command with respect to the managed resource. All the element operations performed by all the elements in response to receiving the commands implements the user requested operation.

### RELATED APPLICATIONS

This application is related to the co-pending and commonly assigned patent application “Method, System, and Program for Generating and Using Configuration Policies”, by Mark A. Carlson and Rowan E. da Silva, and having attorney docket no. P6202, wherein this application is filed on the same date herewith and incorporated herein by reference in its entirety.

### BACKGROUND OF THE INVENTION

1. Field of the Invention

The present invention relates to a method, system, and program for managing multiple resources in a system.

2. Description of the Related Art

A storage area network (SAN) comprises a network linking one or more servers to one or more storage systems. Each storage system could comprise a Redundant Array of Independent Disks (RAID) array, tape backup, tape library, CD-ROM library, or JBOD (Just a Bunch of Disks) components. Storage area networks (SAN) typically use the Fibre Channel protocol, which uses optical fibers to connect devices and provide high bandwidth communication between the devices. In Fibre Channel terms the one or more switches interconnecting the devices is called a “fabric”. However, SANs may also be implemented in alternative protocols, such as InfiniBand**, IPStorage over Gigabit Ethernet, etc. **JIRO, JAVA, SUN, and SUN MICROSYSTEMS are trademarks of Sun Microsystems, Inc. InfiniBand is a service mark of the InfiniBand Trade Association.

In the current art, to add or modify the allocation of storage or other resources in a SAN, an administrator must separately utilize different software programs to configure the SAN resources to reflect the modification to the storage allocation. For instance to allow a host to alter the allocation of storage space in the SAN, the administrator would have to perform one or more of the following:

use a storage device configuration tool to resize a logical volume, such as a logical unit number (LUN), or change the logical volume configuration at the storage device, e.g., the RAID or JBOD, to provide more or less storage space to the host.

a switch configuration tool to alter the assignment of paths in the switch to the host, i.e., rezoning, to provide access to the newly reconfigured logical volume (LUN).

perform LUN masking, which involves altering the assignment of HBA interface ports to the reconfigured LUNs.

use a host volume manager configuration tool to alter the allocation of physical storage to logical volumes used by the host. For instance if the administrator adds storage, then the logical volume must be updated to reflect the added storage.

use a backup program manager to reflect the change in storage allocation so that the backup program will backup more or less data for the host.

use a snapshot copy configuration manager to update the host logical volumes that are subject to a snapshot copy, where a backup copy is made by copying the pointers in the logical volume.

Not only does the administrator have to invoke one or more of the above tools to implement the requested storage allocation change throughout the SAN, but the administrator may also have to perform these configuration operations repeatedly if the configuration of multiple distributed devices is involved. For instance, to add several gigabytes of storage to a host logical volume, the administrator may allocate storage space on different storage subsystems in the SAN, such as different RAID boxes. In such case, the administrator would have to separately invoke the configuration tool for each separate device involved in the new allocation. Further, when allocating more storage space to a host logical volume, the administrator may have to allocate additional storage paths through separate switches that lead to the one or more storage subsystems including the new allocated space. The complexity of the configuration operations the administrator must perform further increases as the number of managed components in a SAN increase. Moreover, the larger the SAN, the increased likelihood of hosts requesting storage space reallocations to reflect new storage allocation needs.

Additionally, many systems administrators are generalists and may not have the level of expertise to use a myriad of configuration tools to appropriately configure numerous different vendor resources. Still further, even if an administrator develops the skill and knowledge to optimally configure networks of components from different vendors, there is a concern for knowledge retention in the event the skilled administrator separates from the organization. Yet further, if administrators are not utilizing their configuration knowledge and skills, then their skill level at performing the configurations may decline.

All these factors, including the increasing complexity of storage networks, decreases the likelihood that the administrator may provide an optimal configuration.

The above described difficulties in configuring resources in a Fibre Channel SAN environment are also experienced in other storage environments including multiple storage devices, hosts, and switches, such as InfiniBand**, IPStorage over Gigabit Ethernet, etc. **JIRO, JAVA, SUN, and SUN MICROSYSTEMS are trademarks of Sun Microsystems, Inc. InfiniBand is a service mark of the InfiniBand Trade Association.

For all the above reasons, there is a need in the art for an improved technique for managing and configuring the allocation of resources in a large network, such as a SAN.

### SUMMARY OF THE PREFERRED EMBODIMENTS

Provided is a method, system, and program for managing multiple resources in a system. A user request for an operation is received that requires performing separate element operations with respect to multiple resources in the system. In response to the user request, commands are communicated to multiple elements, wherein each element is capable of managing one of the resources in the system. For each element receiving at least one of the communicated commands, the element interprets the received commands and performs the element operation requested by the received command with respect to the managed resource. All the element operations performed by all the elements in response to receiving the commands implements the user requested operation.

Further provided is a method, system, and program for managing multiple resources in a system that requires registering a configuration service proxy object and configuration element proxy objects with a lookup service. The configuration service proxy object includes code enabling access to a configuration service capable of configuring resources in the system and the configuration element proxy objects include code enabling access to configuration elements that are capable of configuring system resources. The code in the configuration proxy object is used to communicate a user request for a configuration operation with respect to at least one system resource to the configuration service. The configuration service uses the code in the configuration element proxy objects to communicate commands to the configuration elements to implement the requested configuration operations. In response to receiving the commands from the configuration service, the configuration elements perform a configuration operation on the resource indicated in the received commands.

In further implementations, the user requested configuration operation comprises a request to allocate at least one resource in the system to a host in the system. Further, the request to allocate the system resource may include a request to allocate the storage space to a logical volume in the host. In such case, the resources managed by the configuration elements could comprise a storage device, a switch, a host adaptor, and a volume manager. The configuration element managing the storage device allocates the storage space to the host, the configuration element managing the switch is capable of allocating one or more paths in the switch to the storage device to allow the host to access the allocated storage space, the configuration element managing the host adaptors is capable of allocating one or more host adaptor ports to access the allocated storage space through the switch, and the configuration element managing the volume manager creates the allocated storage space for the requested logical volume.

The configuration service proxy object may enable either remote or local access to the configuration service capable of configuring the system resources.

### BRIEF DESCRIPTION OF THE DRAWINGS

Referring now to the drawings in which like reference numbers represent corresponding parts throughout:

FIG. 1 illustrates a network computing environment for one implementation of the invention;

FIG. 2 illustrates a component architecture in accordance with certain implementations of the invention;

FIG. 3 illustrates a component architecture for a storage network in accordance with certain implementations of the invention;

FIG. 4 illustrates logic to invoke a configuration operation in accordance with certain implementations of the invention; and

FIG. 5 illustrates logic to configure network components in accordance with certain implementations of the invention.

### DETAILED DESCRIPTION

In the following description, reference is made to the accompanying drawings which form a part hereof and which illustrate several embodiments of the present invention. It is understood that other embodiments may be utilized and structural and operational changes may be made without departing from the scope of the present invention.

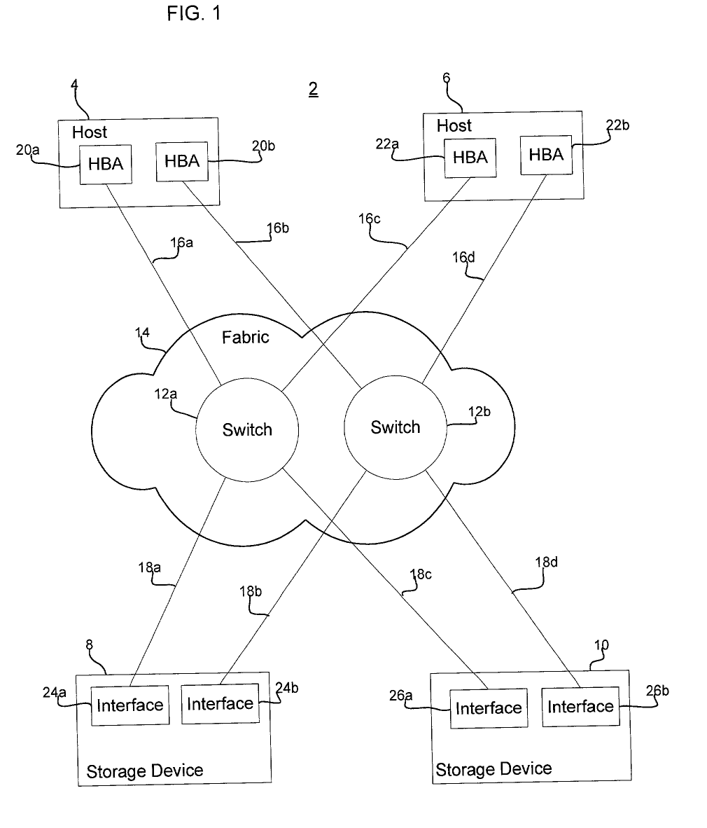

FIG. 1 illustrates an implementation of a Fibre Channel based storage area network (SAN) which may be configured using the implementations described herein. Host computers 4 and 6 may comprise any computer system that is capable of submitting an Input/Output (I/O) request, such as a workstation, desktop computer, server, mainframe, laptop computer, handheld computer, telephony device, etc. The host computers 4 and 6 would submit I/O requests to storage devices 8 and 10. The storage devices 8 and 10 may comprise any storage device known in the art, such as a JBOD (just a bunch of disks), a RAID array, tape library, storage subsystem, etc. Switches 12a, b interconnect the attached devices 4, 6, 8, and 10. The fabric 14 comprises the switches 12a, b that enable the interconnection of the devices. In the described implementations, the links 16a, b, c, d and 18a, b, c, d connecting the devices comprise Fibre Channel fabrics, Internet Protocol (IP) switches, Infiniband fabrics, or other hardware that implements protocols such as Fibre Channel Arbitrated Loop (FCAL), IP, Infiniband, etc. In alternative implementations, the different components of the system may comprise any network communication technology known in the art. Each device 4, 6, 8, and 10 includes multiple Fibre Channel interfaces 20a, 20b, 22a, 22b, 24a, 24b, 26a, and 26b, where each interface, also referred to as a device or host bus adaptor (HBA), can have one or more ports. Moreover, actual SAN implementation may include additional storage devices, hosts, host bus adaptors, switches, etc., than those illustrated in FIG. 1.

A path, as that term is used herein, refers to all the components providing a connection from a host to a storage device. For instance, a path may comprise host adaptor 20a, fiber 16a, switch 12a, fiber 18a, and device interface 24a, and the storage devices or disks being accessed.

Certain described implementations provide a configuration technique that allows administrators to select a specific service configuration policy providing the path availability, RAID level, etc., to use to allocate, e.g., modify, remove or add, storage resources used by a host 4, 6 in the SAN 2. After the service configuration policy is specified, the component architecture implementation described herein automatically configures all the SAN components to implement the requested allocation at the specified configuration quality without any further administrator involvement, thereby streamlining the SAN storage resource configuration and allocation process. The requested allocation of the configuration is referred to as a service configuration policy that implements a particular configuration requested by a by calling the elements to handle the resource configuration. The policy provides a definition of configurations and how these elements in SAN are to be configured. In certain described implementations, the configuration architecture utilizes the Sun Microsystems, Inc. (“SUN”) Jiro distributed computing architecture.** **JIRO, JAVA, SUN, and SUN MICROSYSTEMS are trademarks of Sun Microsystems, Inc. InfiniBand is a service mark of the InfiniBand Trade Association.

Jiro provides a set of program methods and interfaces to allow network users to locate, access, and share network resources, referred to as services. The services may include hardware devices, software devices, application programs, storage resources, communication channels, etc. Services are registered with a central lookup service server, which provides a repository of service proxies. A network participant may review the available services at the lookup service and access service proxy objects that enable the user to access the service through the service provider. A “proxy object” is an object that represents another object in another memory or program memory address space, such as a resource at a remote server, to enable access to that resource or object at the remote location. Network users may “lease” a service, and access the proxy object implementing the service for a period of time.

A service provider discovers lookup services and then registers service proxy objects and service attributes with the discovered lookup service. In Jiro, the service proxy object is written in the Java** programming language, and includes methods and interfaces to allow users to invoke and execute the service object located through the lookup service. A client accesses a service proxy object by querying the lookup service. The service proxy object provides Java interfaces to enable the client to communicate with the service provider and access the service available through the network. In this way, the client uses the proxy object to communicate with the service provider to access the service. **JIRO, JAVA, SUN, and SUN MICROSYSTEMS are trademarks of Sun Microsystems, Inc. InfiniBand is a service mark of the InfiniBand Trade Association.

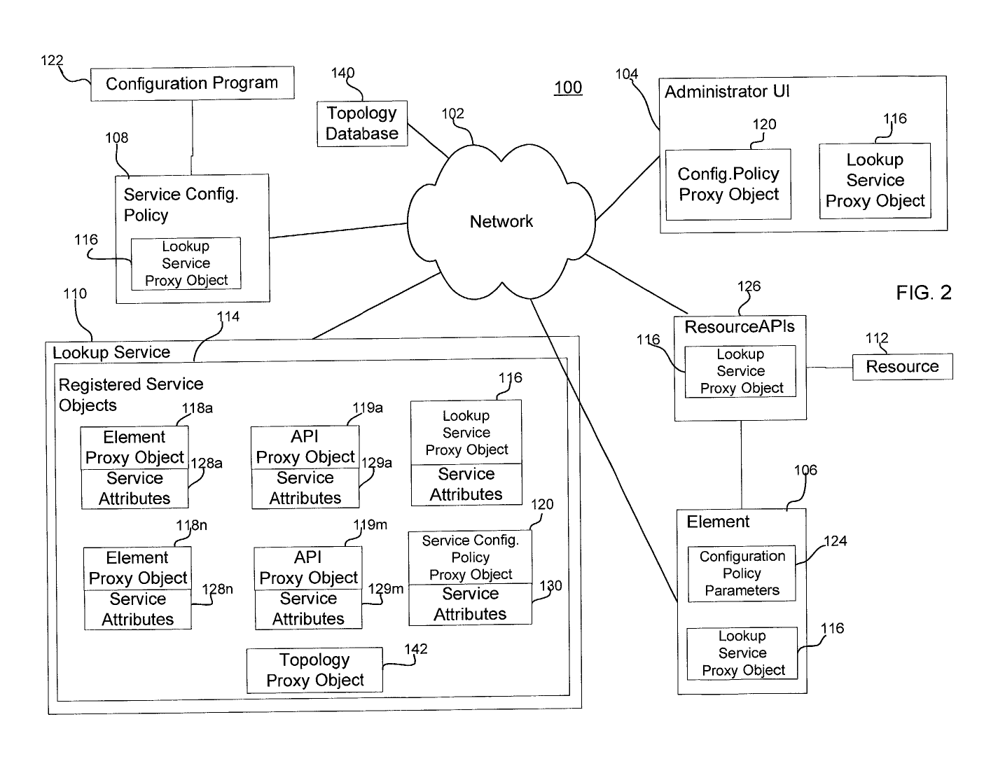

FIG. 2 illustrates a configuration architecture 100 using Jiro components to configure resources available over a network 102, such as hosts, switches, storage devices, etc. The network 102 may comprise the fiber links provided through the fabric 14. The network 102 allows for communication among an administrator user interface (UI) 104, one or more elements 106 (only one is shown, although multiple elements 106 may be present), one or more configuration policy services (only one is shown) 108, and a lookup service 110.

The network 102 may comprise the Internet, an Intranet, a LAN, etc., or any other network system known in the art, including wireless and non-wireless networks. The administrator UI 104 comprises a system that submits requests for access to network resources. For instance, the administrator UI 104 may request a new allocation of storage resources to hosts 4, 6 (FIG. 1) in the SAN 2. The administrator UI 104 may be implemented as a program within the host 4, 6 involved in the new storage allocation or a within system remote to the host. The administrator UI 104 provides access to the configuration resources described herein to alter the configuration of storage resources to hosts. The elements 106 provide a management interface to provide configuration and control over a resource 112. In SAN implementations, the resource 112 may comprise any resource in the system that is configured during the process of allocating resources to a host. For instance, the configurable resources 112 may include host bus adaptors 20a, b, 22a, b, a host volume manager which provides an assignment of logical volumes in the host 4, 6 to physical storage space in storage devices 8,10, a backup program in the host 4, 6, a snapshot program in the host 4, 6 providing snapshot services (i.e., copying of pointers to logical volumes), switches 12a, b, storage devices 8, 10, etc. Multiple elements may be defined to provide different configuration qualities for a single resource. Each of the above components in the SAN would comprise a separate resource 112 in the system, where one or more elements 106 are provided for management and configuration of the resource. The service configuration policy 108 implements a particular configuration requested by the host 104 by calling the elements 106 to configure the resources 112.

In the architecture 100, the element 106, service configuration policy 108, and resource APIs 126 function as Jiro service providers that make services available to any network participant, including to each other and to the administrator UI 104. The lookup service 110 provides a Jiro lookup service in a manner known in the art. The lookup service 110 maintains registered service objects 114, including a lookup service proxy object 116, that enables network users, such as the administrator UI 104, elements 106, service configuration policies 108, and resource APIs 126 to access the lookup service 110 and the proxy objects 116, 118a . . . n, 119a . . . m, and 120 therein. For instance, each element 106 registers an element proxy object 118a . . . n, each resource API 126 registers an API proxy object 119a . . . m, and each service configuration policy 108 registers a service configuration policy proxy object 120 to provide access to the underlying resources. The service configuration policy 108 includes code to call elements 106 to perform the user requested configuration operations to reallocate storage resources to a specified host and logical volume.

With respect to the elements 106, the resources 112 comprise the underlying service resource being managed by the element 106, e.g., the storage devices 8, 10, host bus adaptors 16a, b, c, d, switches 12a, b, host volume manager, backup program, snapshot program, etc. The resource application program interfaces (APIs) 126 provide access to the configuration functions of the resource to perform the resource specific configuration operations. Thus, there is one resource API set 126 for each managed resource 112. The APIs 126 are accessible through the API proxy objects 119a . . . m. Because there may be multiple elements to provide different configurations of a resource 112, the number of registered element proxy objects n may exceed the number of registered API proxy objects m, because the multiple elements 106 that provide different configurations of the same resource 112 would use the same set of APIs 126.

The element 106 includes configuration policy parameters 124 that provide the settings and parameters to use when calling the APIs 126 to control the configuration of the resource 112. If there are multiple elements 106 for a single resource 112, then each of those elements 106 may provide a different set of configuration policy parameters 124 to configure the resource 112. For instance, if the resource 112 is a RAID storage device, then the configuration policy parameters 124 for one element may provide a RAID level abstract configuration, or some other defined RAID configuration, such as Online Analytical Processing (OLAP) RAID definitions and configurations which may define a RAID level, number of disks, etc. Another element may provide a different RAID level. Additionally, if the resource 112 is a switch, then the configuration policy parameters 124 for one element 106 may configure redundant paths through the switch to the storage space to avoid a single point of failure, whereas another element for the switch may configure only a single path. Thus, the elements 106 utilize the configuration policy parameters 124 and the resource API 126 to control the configuration of the resource 112, e.g., storage device 8, 10, switches 12a, b, volume manager, backup program, host bus adaptors (HBAs) 20a, b, 22a, b, etc.

Each service configuration policy 108 would call one of the elements 106 for each resource 112 to perform the administrator/user requested reconfiguration. There may be multiple service configuration policies for different predefined configuration qualities. For instance, there may be a higher quality service configuration policy, such as “gold”, for critical data that would call one element 106 for each resource 112 to reconfigure, where the called element 106 configures the resource 112 to provide for extra protection, such as a high RAID level, redundant paths through the switch to the storage space to avoid a single point of failure, redundant use of host bus adaptors to further reduce a single point of failure at the host, etc. A “bronze” or lower quality service configuration policy may not require such redundancy and protection to provide storage space for less critical data. The “bronze” quality service configuration policy 108 would call the elements 106 that implement such a lower quality configuration policy with respect to the resources 112. Each called element 106 in turn calls the APIs 126 for the resource to reconfigure. Note that different service configuration policies 108 may call the same or different elements 106 to configure a particular resource.

Associated with each proxy object 118a . . . n, 119a . . . m, and 120 are service attributes 128a . . . n, 129a . . . n, and 130 that provide descriptive attributes of the proxy objects 118a . . . n, 119a . . . n, and 120. For instance, the administrator UI 104 may use the lookup service proxy object 116 to query the service attributes 130 of the service configuration policy 108 to determine the quality of service provided by the configuration policy, e.g., the RAID level, number of redundant paths, etc. The service attributes 128a . . . n for the elements 106 may describe the type of configuration performed by the specific element.

FIG. 2 further illustrates a topology database 140 which provides information on the topology of all the resources in the system, i.e., the connections between the host bus adaptors, switches and storage devices. The topology database 140 may be created during system initialization and updated whenever changes are made to the system configuration in a manner known in the art. For instance, the Fibre Channel and SCSI protocols provide protocols for discovering all of the components or nodes in the system and their connections to other components. Alternatively, out-of-band discovery techniques could utilize Simple Network Management Protocol (SNMP) commands to discover all the devices and their topology. The result of the discovery process is the topology database 140 that includes entries identifying the resources in each path in the system. Any particular resource may be available in multiple paths. For instance, a switch may be in multiple entries as the switch may provide multiple paths between different host bus adaptors and storage devices. The topology database 140 can be used to determine whether particular devices, e.g., host bus adaptors, switches and storage devices, can be used, i.e., are actually interconnected. The lookup service 114 maintains a topology proxy object 142 that provides methods for accessing the topology database 140 to determine how components in the system are connected.

When the service configuration policy proxy object 120 is created, the topology database 140 may be queried to determine those resources that can be used by the service configuration policy 108, i.e., those resources that when combined can satisfy the configuration policy parameters 124 of the elements 106 defined for the service configuration policy 108. The service configuration policy proxy object service attributes 130 may be updated to indicate the query results of those resources in the system that can be used with the configuration. The service attributes 130 may further provide topology information indicating how the resources, e.g., host bus adaptors, switches, and storage devices, are connected or form paths. In this way, the configuration policy proxy object service attributes 130 defines all paths of resources that satisfy the configuration policy parameters 124 of the elements 106 included in the service configuration policy.

In the architecture of FIG. 2, the service providers 108 (configuration policy service), 106 (element), and resource APIs 126 function as clients when downloading the lookup service proxy object 116 from the lookup service 110 and when invoking lookup service proxy object 116 methods and interfaces to register their respective service proxy objects 118a . . . n, 119a . . . m, and 120 with the lookup service 110. The client 104 and service providers 106 and 108 would execute methods and interfaces in the service proxy objects 118a . . . n, 119a . . . m, and 120 to communicate with the service provider 106, 108, and 126 to access the associated service. The registered service objects 118a . . . n, 119a . . . m, and 120 comprise the services available through the lookup service 110. The administrator UI 104 uses the lookup service proxy object 116 to access the proxy objects from the lookup service 110. Further details on how clients may discover and download the lookup service and service objects and register service objects are described in the Sun Microsystem, Inc. publications: “Jini Architecture Specification” (Copyright 2000, Sun Microsystems, Inc.) and “Jini Technology Core Platform Specification” (Copyright 2000, Sun Microsystems, Inc.), both of which publications are incorporated herein by reference in their entirety.

The resources 112, elements 106, service configuration policy 108, and resource APIs 126 may be implemented in any computational device known in the art and each include a Java Virtual Machine (JVM) and a Jiro package (not shown). The Jiro package includes all the Java methods and interfaces needed to implement the Jiro network environment in a manner known in the art. The JVM translates methods and interfaces of the Jiro package as well as the methods and interfaces of downloaded service objects, into bytecodes capable of executing on the configuration policy service 108, administrator UI 104 element 106, and resource APIs 126. Each component 104, 106, 108, and 110 further includes a network protocol stack (not shown) to enable communication over the network. The network protocol stack provides a network address for the components 104, 106, 108, 110, and 126, such as a Transmission Control Protocol/Internet Protocol (TCP/IP) address, support for unicast and multicast broadcasting, and a mechanism to facilitate the downloading of Java files. The network protocol stack may also include the communication infrastructure to allow objects, including proxy objects, on the systems to communicate, such as the Common Object Request Broker Architecture (CORBA), Remote Method Invocation (RMI), TCP/IP, etc.

As discussed, the configuration architecture may include multiple elements for the different configurable resources in the storage system. Following are the resources that may be configured through the proxy objects in the SAN:

Storage Devices: There may be a separate element service for each configurable storage device 8, 10. In such case, the resource 112 would comprise the configurable storage space of the storage devices 8, 10 and the element 106 would comprise the configuration software for managing and configuring the storage devices 8, 10 according to the configuration policy parameters 124. The element 106 would call the resource APIs 126 to access the functions of the storage configuration software.

Switch: There may be a separate element service for each configurable switch 12a, b. In such case, the resource 112 would comprise the paths in the switch and the element 106 would comprise the switch software for managing and configuring paths within the switch 12a, b according to the configuration policy parameters 124. The element 106 would call the resource APIs 126 to access the functions of the switch configuration software.

Host Bus Adaptors: There may be a separate element service to manage the allocation of the host bus adaptors 20a, b, 22a, b on each host 4, 6. In such case, the resource 112 would comprise all the host bus adaptors (HBAs) on a given host and the elements would comprise the configuration software for assigning the host bus adaptors (HBAs) to a path according to the configuration policy parameters 124. The element 106 would call the resource APIs 126 to access the functions of the host adaptor configuration software on each host 4, 6.

Volume Manager on the Host: There may be a separate element service for the volume manager on each host 4, 6. In such case, the resource 112 would comprise the mapping of logical to physical storage and the element 106 would comprise the software for configuring the mapping of the logical volumes viewed by the host 4, 6 to physical storage space in the storage devices 8, 10 according to the configuration policy parameters 124. The element 106 would call the resource APIs 126 to access the functions of the volume manager configuration software.

Backup Program on the Host: There may be a separate element service 106 for the backup program configuration at each host 4, 6. In such case, the resource 112 would comprise the configurable backup program for the host 4, 6 and the element 106 would comprise software for managing and configuring backup operations for the host 4, 6 according to the configuration policy parameters 124. The element 106 would call the resource APIs 126 to access the functions of the backup management software.

Snapshot on the Host: There may be a separate element service 106 for the snapshot configuration for each host 4, 6. In such case, the resource 112 would comprise the snapshot operation on the host and the element 106 would comprise the software to select logical volumes to copy as part of a snapshot operation according to the configuration policy parameters 124. The element 106 would call the resource APIs 126 to access the functions of the snapshot configuration software.

Element services may also be provided for other network based storage devices and host based storage software other than those described herein.

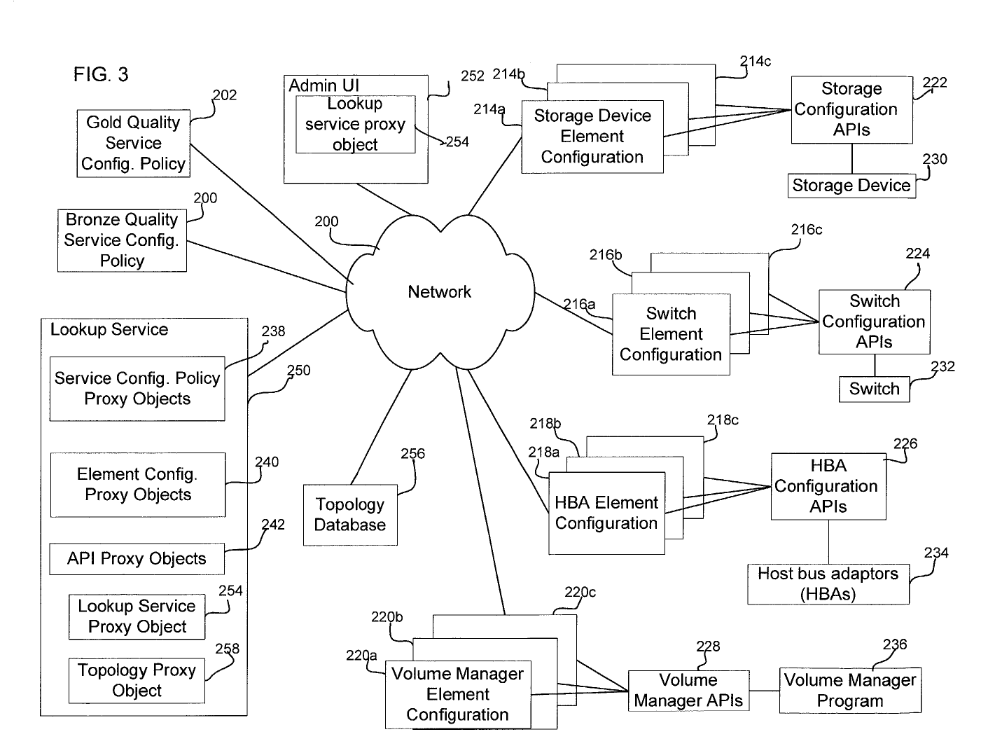

FIG. 3 illustrates an additional arrangement of the element, service configuration policies, and APIs for the SAN components that may be available over a network 200, including a gold 202 and bronze 204 quality service configuration polices, each providing a different quality of configuration for the system components. The service configuration policies 202 and 204 call one device configuration element for each resource that needs to be configured. The component architecture includes one or more storage device element configurations 214a, b, c, switch element configurations 216a, b, c, host bus adaptor (HBA) element configurations 218a, b, c, and volume manager element configurations 220a, b, c. The configuration elements 214a, b, c, 216a, b, c, 218a, b, c, and 220a, b, c call the resource APIs 222, 224, 226, and 228, respectively, that enable access and control to the commands and functions used to configure the storage device 230, switch 232, host bus adaptors (HBA) 234, and volume manager 236, respectively. In certain implementations, the resource API proxy objects include service attributes that describe the availability of resources for the device which the particular API resources manage, i.e., available storage space, available paths, available host bus adaptor, etc. In the described implementations, there is a separate resource API object for each instance of the device, such that if there are two storage devices in the system, then there would be two storage configuration APIs, each providing the APIs to one of the storage devices. Further, the proxy object for each resource API would include service attributes describing the availability at the resource to which the resource API provides access.

Each of the service configuration policies 202 and 204, configuration elements 214a, b, c, 216a, b, c, 218a,b , c, and 220a, b, c, and resource APIs 222, 224, 226, and 228 would register their respective proxy objects with the lookup service 250. For instance, the service configuration policy proxy objects 238 include the proxy objects for the gold 202 and bronze 200 quality service configuration polices; the element configuration proxy objects 240 include the proxy objects for each element 214a, b, c, 216a, b, c, 218a, b, c, 220a, b, c configuring a resource 230, 232, 234, and 236; and the API proxy objects 242 include the proxy objects for each set of device APIs 222, 224, 226, and 228. As discussed each service configuration policy 200, 202 would call one element for each of the resources 230, 232, 234, and 236 that need to be configured to implement the user requested configuration quality. Each device configuration element 214a, b, c, 216a, b, c, 218a, b, c, and 220a, b, c maintains configuration policy parameters (not shown) that provides a particular quality of configuration of the managed resource. Moreover, additional device element configurations would be provided for each additional devices in the system. For instance, if there were two storage devices in the SAN system, such as a RAID box and a tape drive, there would be separate element configurations to manage each different storage device and separate proxy objects and accompanying APIs to allow access to each of the element configurations for the storage devices. Further, there would be one or more host bus adaptor (HBA) element configurations for each host system to allow configuration and management of all the host bus adaptors (HBAs) in a particular host 4, 6 (FIG. 1). Each proxy object would include service attributes providing information on the resource being managed, such as the amount of available disk space, available paths in the switch, available host bus adaptors at the host, configuration quality and configuration parameters, etc.

An administrator user interface (UI) 252 operates as a Jiro client and provides a user interface to enable access to the lookup service proxy object 254 from the lookup service 250 and enable access to the lookup service proxy object 254 to access the service configuration policies 202 and 204. The administrator 252 is a process running on any system, including the device components shown in FIG. 3, that provides a user interface to access, run, and modify configuration policies. The service configuration policies 202, 204 call the configuration elements 214a, b, c, 216a, b, c, 218a, b, c, and 220a, b, c to configure each resource 230, 232, 234, 236 to implement the allocation of the additional requested storage space to the host. The service configuration polices 202, 204 would provide a graphical user interface (GUI) to enable the administrator to enter resources to configure. Before a user at the administrator UI 252 could utilize the above described component architecture of FIG. 3 to configure components of a SAN system, e.g., the SAN 2 in FIG. 1, the service configuration policies 202, 204, element configurations 214a, b, c, 216a, b, c, 218a, b, c, and 220a, b, c would have to discover and join the lookup service 250 to register their proxy objects. Further, each of the service configuration policies 202 and 204 must download the element configuration proxy objects 240 for the elements 214a, b, c, 216a, b, c, 218a, b, c, and 220a, b, c. The elements 214a, b, c, 216a, b, c, 218a, b, c, and 220a, b, c, in turn, must download one of the API proxy objects 242 for resource APIs 222, 224, 226, and 228, respectively, to perform the desired configuration according to the configuration policy parameters maintained in the element and the host storage allocation request.

FIG. 3 further shows a topology database 256 and topology proxy object 258 that maintains the topology information on the database. Each record may specify the resources in a path.

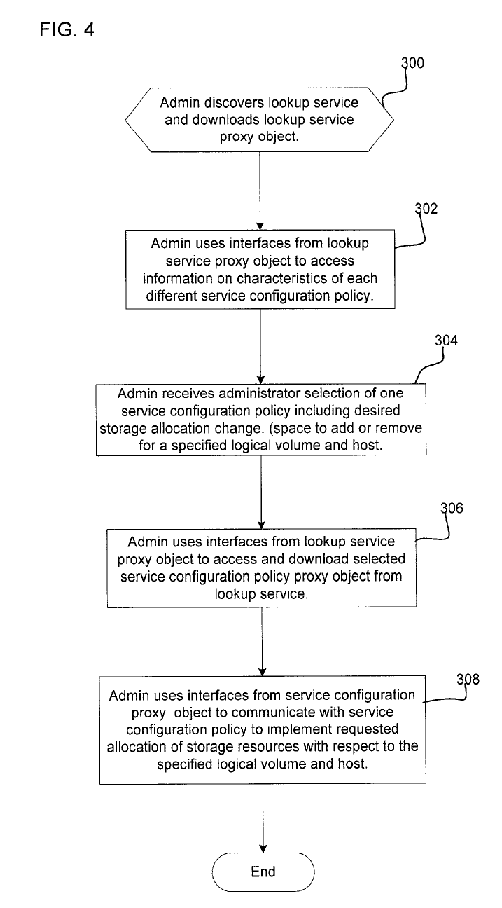

FIG. 4 illustrates logic implemented within the administrator UI 252 to begin the configuration process utilizing the configuration architecture described with respect to FIGS. 2 and 3. Control begins at block 300 with the administrator UI 252 (“admin”) discovering the lookup service 250 and downloading the lookup service proxy object 254. The administrator UI 252 then uses (at block 302) the interfaces of the lookup service proxy object 254 to access information on the service attributes providing information on each service configuration policy 202 and 204, such as the quality of availability and path redundancy. A user may then select one of the service configuration policies 202 and 204 appropriate to the availability and redundance needs of the application that will use the new allocation of storage. For instance, a critical database application would require high availability and redundancy, whereas an application involving non-critical data requires less availability and redundancy. The administrator UI 252 then receives user selection (at bock 304) of one of the service configuration policies 202, 204 and a host and logical volume and other device components, such as switch 232 and storage device 230 to configure for the new storage allocation. The administrator UI 252 may execute within the host to which the new storage space will be allocated or be remote to the host.

The administrator UI 252 then uses (at block 306) interfaces from the lookup service proxy object 254 to access and download the selected service configuration policy proxy object. The administrator UI 252 uses (at block 308) interfaces from the downloaded service configuration policy proxy object to communicate with the selected service configuration policy 202 or 204 to implement the requested storage allocation for the specified logical volume and host.

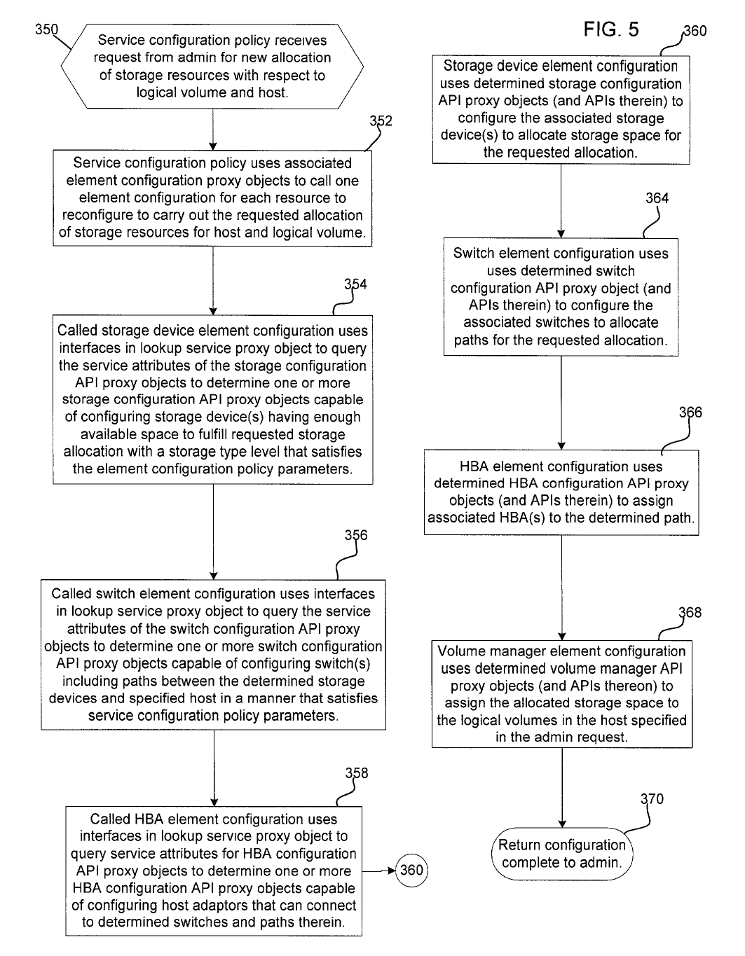

FIG. 5 illustrates logic implemented in the service configuration policy 202, 204 and element configurations 214a, b, c, 216a, b, c, 218a, b, c, 220a, b, c to perform the requested configuration operation. Control begins at block 350 when the service configuration policy 202, 204 receives a request from the administrator UI 252 for a new allocation of storage space for a logical volume and host through the configuration policy service proxy object 238, 240. In response, the selected service configuration policy 202, 204 calls (at block 352) one associated element configuration proxy object for each resource 222, 224, 226, 228 that needs to be configured to implement the allocation. In the logic described at blocks 354 to 370, the service configuration policy 202, 204 configures the following resources, the storage device 230, switch 232, host bus adaptors 234, and volume manager 236 to carry out the requested allocation. Additionally, the service configuration policy 202, 204 may call elements to configure more or less resources. For instance, for certain configurations, it may not be necessary to assign an additional path to the storage device for the added space. In such case, the service configuration policy 202, 204 would only need to call the storage device element configuration 214a, b, c and volume manager element configuration 220a, b, c to implement the requested allocation.

At block 354, the called storage device element configuration 214a, b, c uses interfaces in the lookup service proxy object 254 to query the service attributes of the storage configuration APIs 222 for storage devices 230 in the system to determine one or more storage configuration API proxy objects capable of configuring storage device(s) 230 having enough available space to fulfill requested storage allocation with a storage type level that satisfies the element configuration policy parameters. For instance, the gold service configuration policy 202 will call device element configurations that provide for redundancy, such as RAID 5 and redundant paths to the storage space, whereas the bronze service configuration policy may not require redundant paths or a high RAID level.

The called switch element configuration 216a, b, c uses (at block 356) interfaces in the lookup service proxy object 254 to query the service attributes of the switch configuration API proxy objects to determine one or more switch configuration API proxy objects capable of configuring switch(s) 132 including paths between the determined storage devices and specified host in a manner that satisfies the called switch element configuration policy parameters. For instance, the gold service configuration policy 202 may require redundant paths through the same or different switches to improve availability, whereas the bronze service configuration policy 200 may not require redundant paths to the storage device.

The called HBA element configuration 218a, b, c uses (at block 358) interfaces in lookup service proxy object 254 to query service attributes for HBA configuration API proxy objects to determine one or more HBA configuration API proxy objects capable of configuring host bus adaptors 234 that can connect to the determined switches and paths that are allocated to satisfy the administrator request.

Note that the above determination of storage devices, switches and host bus adaptors may involve the called device element configuration performing multiple iterations to find some combination of components that can provide the requested storage space allocation to the specified logical volume and host and additionally satisfy the element configuration policy parameters.

After determining the resources 230, 232, and 234 to use to fulfill the administrator UI's 252 storage allocation request, the called device element configurations 214a, b, c, 216a, b, c, 218a, b, c, and 220a, b, c call the determined configuration APIs to perform the user requested allocation. At block 360, the previously called storage device element configuration 214a, b, c uses the one or more determined storage configuration API proxy objects 224, the APIs therein, to configure the associated storage device(s) to allocate storage space for the requested allocation. At block 364, the switch element configuration 216a, b, c uses the one or more determined switch configuration API proxy objects, and APIs therein, to configure the associated switches to allocate paths for the requested allocation.

At block 366, the previously called HBA element configuration 218a, b, c uses the determined HBA configuration API proxy objects, and APIs therein, to assign the associated host bus adaptors 234 to the determined path.

At block 368, the volume manager element configuration 220a, b, c uses the determined volume manager API proxy objects, and APIs therein, to assign the allocated storage space to the logical volumes in the host specified in the administrator UI request.

The configuration APIs 222, 224, 226, 228, may grant element configurations 214a, b, c, 216a, b, c, 218a, b, c, 220a, b, c access to the API resources on an exclusive or non-exclusive basis according to the lease policy for the configuration API proxy objects.

The described implementations thus provide a technique to allow for automatic configuration of numerous SAN resources to allocate storage space for a logical volume on a specified host. In the prior art, users would have to select components to assign to an allocation and then separately invoke different configuration tools for each affected component to implement the requested allocation. With the described implementation, the administrator UI or other entity need only specify the new storage allocation one time, and the configuration of the multiple SAN components is performed by singularly invoking one service configuration policy 200, 202, that then invokes the device element configurations.

### Additional Implementation Details

The described implementations may be realized as a method, apparatus or article of manufacture using standard programming and/or engineering techniques to produce software, firmware, hardware, or any combination thereof. The term “article of manufacture” as used herein refers to code or logic implemented in hardware logic (e.g., an integrated circuit chip, Field Programmable Gate Array (FPGA), Application Specific Integrated Circuit (ASIC), etc.) or a computer readable medium (e.g., magnetic storage medium (e.g., hard disk drives, floppy disks, tape, etc.), optical storage (CD-ROMs, optical disks, etc.), volatile and non-volatile memory devices (e.g., EEPROMs, ROMs, PROMs, RAMs, DRAMs, SRAMs, firmware, programmable logic, etc.). Code in the computer readable medium is accessed and executed by a processor. The code in which preferred embodiments of the configuration discovery tool are implemented may further be accessible through a transmission media or from a file server over a network. In such cases, the article of manufacture in which the code is implemented may comprise a transmission media, such as a network transmission line, wireless transmission media, signals propagating through space, radio waves, infrared signals, etc. Of course, those skilled in the art will recognize that many modifications may be made to this configuration without departing from the scope of the present invention, and that the article of manufacture may comprise any information bearing medium known in the art.

The implementations were described with respect to the Sun Microsystems, Inc. Jiro network environment that provides distributed computing. However, the described technique for configuration of components may be implemented in alternative network environments where a client downloads an object or code from a server to use to access a service and resources at that server. Moreover, the described configuration policy services and configuration elements that were described as implemented in the Java programming language as Jiro proxy objects may be implemented in any computer architecture known in the art and coded using any known programming language to perform the functions described herein.

In the described implementations, the storage comprised network storage accessed over a network. Additionally, the configured storage may comprise a storage device directly attached to the host.

The described logic of FIGS. 4 and 5 concerned a request to add additional storage space to a logical volume. However, the above described architecture and configuration technique may apply to other types of operations involving the allocation of storage resources, such as freeing-up space from one logical volume or requesting a reallocation of storage space from one logical volume to another.

The configuration policy services 202, 204 may control the configuration elements 214a, b, c, 216a, b, c, 218a, b, c, and 220a, b, c over the Fibre Channel links or use an out-of-band communication channel, such as through a separate LAN connecting the devices 230, 232, and 234.

The configuration elements 214a, b, c, 216a, b, c, 218a, b, c, and 220a, b, c may be located on the same computing device including the requested resource, e.g., storage device 230, switch 232, host bus adaptors 234, or be located at a remote location from the resource being managed and configured.

In the described implementations, the service configuration policy service configures a switch when allocating storage space to a specified logical volume in a host. Additionally, if there are no switches (fabric) in the path between the specified host and storage device including the allocated space, there would be no configuration operation performed with respect to the switch.

In the described implementations, the service configuration policy was used to control elements related to the components within a SAN environment. Additionally, the configuration architecture of FIG. 2 may apply to any system in which an operation is performed, such as an allocation of resources, that requires the management and configuration of different resources throughout the system. In such cases, the elements may be associated with any element within the system that is manipulated through a configuration policy service.

In the described implementations, the architecture was used to alter the allocation of resources in the system. Additionally, the described implementations may be used to control system components through the elements to perform operations other than configuration operations, such as operations managing and controlling the device.

The above implementations were described with respect to a Fibre Channel environment. Additionally, the above described implementations of the invention may apply to other network environments, such as InfiniBand, Gigabit Ethernet, TCP/IP, the Internet, etc.

In the above described implementations, specific operations were described as being performed by a service configuration policy, device element configuration and device APIs. Alternatively, functions described as being performed with respect to one type of object may be implemented in another object. For instance, operations described as performed with respect to the element configurations may be performed by the service configuration policies.

The foregoing description of the implementations of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. A method for managing multiple resources in a system, comprising:
receiving a user request for an operation that requires performing separate element operations with respect to multiple resources in the system;
in response to the user request, communicating commands to multiple elements, wherein each element is capable of managing one of the resources in the system;
for each element receiving at least one of the communicated commands, performing:
(i) interpreting the received command;
(ii) performing the element operation requested by the received command with respect to the managed resource, wherein all the element operations performed by all the elements in response to receiving the commands implement the user requested operation.

2. The method of claim 1, wherein the user requested operation comprises a request to allocate at least one resource in the system to a host in the system, and wherein the element operations requested by the received command comprise configuration operations to configure the managed resources to implement the user requested resource allocation.

3. The method of claim 2, wherein the request to allocate the at least one system resource comprises a request to allocate additional storage space in the system to the host.

4. The method of claim 3, wherein the request to allocate the at least one system resource includes a request to allocate the storage space to a logical volume in the host, wherein the resources managed by the elements comprise a storage device, a switch, a host adaptor, file system, and a volume manager, wherein the element managing the storage device allocates the storage space to the host, wherein the element managing the switch is capable of allocating at least one path in the switch to the storage device to allow the host to access the allocated storage space, wherein the element managing the host adaptors allocates at least one host adaptor in the host to communicate with the switch to access the allocated storage space, and wherein the element managing the volume manager assigns the allocated storage space in the device to the requested logical volume used by the host.

5. The method of claim 4, wherein the system is capable of including multiple storage devices, switches, and host adaptors in the host, and wherein there is at least one separate element to manage each storage device and switch in the system.

6. The method of claim 5, further comprising:
in response to the communicated commands, determining, with the elements, at least one switch and storage device in the system capable of supplying the storage and path resources to satisfy the user request, wherein the commands are communicated to the elements managing the determined switches and storage devices.

7. The method of claim 1, wherein each resource in the system is capable of being managed by multiple elements, wherein each of multiple elements for one resource performs the element operation in a different manner than other elements.

8. The method of claim 7, wherein there is an application program interface (API) set for each resource in the system, wherein the multiple element objects capable of managing one resource call the same API set to perform operations with respect to the managed resource.

9. The method of claim 1, wherein the commands are communicated by using element proxy objects registered with a lookup service.

10. A method for managing multiple resources in a system, comprising:
registering a configuration service proxy object with a lookup service, wherein the configuration service proxy object includes code enabling access to a configuration service capable of configuring resources in the system;
registering configuration element proxy objects with the lookup service, wherein the configuration element proxy objects include code enabling access to element configurations that are capable of configuring system resources;
using the code in the configuration proxy object to communicate a user request for a configuration operation with respect to at least one system resource to the configuration service; and
using, with the configuration service, the code in the configuration element proxy objects to communicate commands to the configuration elements to implement the requested configuration operations; and
in response to receiving the commands from the configuration service, performing, with the configuration elements, a configuration operation on the resource indicated in the received commands.

11. The method of claim 10, wherein all the configuration operations performed by all the configuration elements in response to receiving commands from the configuration service implement the user requested configuration operation.

12. The method of claim 10, wherein the user requested configuration operation comprises a request to allocate a resource in the system to a host in the system, and wherein the configuration operations performed by the configuration elements receiving the commands from the configuration service implement the user requested resource allocation.

13. The method of claim 12, wherein the user requested resource allocation comprises a request to allocate more storage space in the system to the host.

14. The method of claim 10, wherein the request to allocate the system resource includes a request to allocate the storage space to a logical volume in the host, wherein the resources managed by the configuration elements comprise a storage device, a switch, a host adaptor, and a volume manager, wherein the configuration element managing the storage device allocates the storage space to the host, wherein the configuration element managing the switch is capable of allocating one or more paths in the switch to the storage device to allow the host to access the allocated storage space, wherein the configuration element managing the host adaptors is capable of allocating one or more host adaptors to access the allocated storage space through the switch, and wherein the configuration element managing the volume manager assigns the allocated storage space to the requested logical volume.

15. The method of claim 10, wherein the system is capable of including multiple storage devices, switches, and host adaptors in the host, and wherein there is at least one separate configuration element to manage each storage device and switch in the system.

16 The method of claim 15, further comprising:
in response to the user request, determining, with the configuration elements, at least one switch, storage device, and host adaptor in the system capable of supplying the storage and path resources to satisfy the user request, wherein the configuration elements configure the determined switches and storage devices.

17. The method of claim 16, wherein the configuration elements query information on the system components to determine the system components capable of satisfying the user requested configuration operation.

18. The method of claim 16, wherein configuration policy parameters are provided with each configuration element that specify how each configuration element configure the associated switch, storage device, or host adaptor.

19. The method of claim 18, wherein the configuration policy parameters specify a level of availability to provide with the allocated storage space.

20. The method of claim 14, wherein there are multiple configuration services calling different sets of elements to provide different qualitiess of configurations, further comprising:
selecting one of the configuration services.

21. The method of claim 14, wherein the system is further capable of including backup programs and snapshot image programs, wherein there is at least one configuration element to manage each backup program and snapshot image program in each host.

22. The method of claim 10, wherein each resource in the system is capable of having multiple elements, wherein each of the multiple elements provided to configure one resource configure the resource differently.

23. The method of claim 22, wherein there is an application program interface (API) proxy object for each resource in the system, wherein the multiple elements capable of configuring one resource use the same API proxy object to configure the associated resource.

24. The method of claim 10, wherein the configuration service proxy object enables either remote or local access to the configuration service to configure capable of configuring resources in the system

25. A method for managing multiple resources in a system, comprising:
invoking a management program;
providing the management program a set of user specified operational parameters to use for a system operation performed with respect to the system resources;
calling, with the management program multiple elements, wherein each element is capable of managing one of the resources in the system by performing an element operation;
for each element called by the management program, performing:
(i) interpreting the received command;
(ii) performing the element operation requested by the received command with respect to the managed resource, wherein the elements control the managed resource according to predefined element operational parameters and the user specified operational parameters.

26. The method of claim 25, wherein the user specified operational parameters comprise a request to allocate at least one resource in the system to a host in the system, wherein the element operations comprise configuration operations to configure the managed resources to implement the user specified resource allocation.

27. The method of claim 26, wherein the request to allocate the at least one system resource comprises a request to allocate additional storage space in the system to the host.

28. The method of claim 27, wherein the request to allocate the at least one system resource includes a request to allocate the storage space to a logical volume in the host, wherein the resources managed by the elements comprise a storage device, a switch, a host adaptor, file system, and a volume manager, wherein the element managing the storage device allocates the storage space to the host, wherein the element managing the switch is capable of allocating at least one path in the switch to the storage device to allow the host to access the allocated storage space, wherein the element managing the host adaptors allocates at least one host adaptor in the host to communicate with the switch to access the allocated storage space, and wherein the element managing the volume manager assigns the allocated storage space in the device to the requested logical volume used by the host.

29. The method of claim 28, wherein the system is capable of including multiple storage devices, switches, and host adaptors in the host, and wherein there is at least one separate element to manage each storage device and switch in the system.

30. The method of claim 25, wherein each resource in the system is capable of being managed by multiple elements, wherein each of multiple elements for one resource performs the operation in a different manner than other elements.

31. The method of claim 30, wherein there are multiple management programs, wherein each management program calls one of the multiple elements for each resource to control, and wherein different management programs call different elements for at least one resource to perform different operations with respect to the resource.

32. A system for managing multiple resources, comprising:
multiple resources;
means for receiving a user request for an operation that requires performing separate element operations with respect to the multiple resources in the system;
means for communicating, in response to the user request, commands to multiple elements, wherein each element is capable of managing one of the resources in the system;
multiple element means for performing, in response to receiving at least one of the communicated commands, interpreting the received command and performing the element operation requested by the received command with respect to the managed resource, wherein all the element operations performed by all the elements in response to receiving the commands implement the user requested operation.

33. The system of claim 32, wherein the user requested operation comprises a request to allocate at least one resource in the system to a host in the system, and wherein the element operations requested by the received command comprise configuration operations to configure the managed resources to implement the user requested resource allocation.

34. The system of claim 33, wherein the request to allocate the at least one system resource comprises a request to allocate additional storage space in the system to the host.

35. The system of claim 34, wherein the request to allocate the at least one system resource includes a request to allocate the storage space to a logical volume in the host, wherein the resources managed by the elements comprise a storage device, a switch, a host adaptor, file system, and a volume manager, wherein the element managing the storage device allocates the storage space to the host, wherein the element managing the switch is capable of allocating at least one path in the switch to the storage device to allow the host to access the allocated storage space, wherein the element managing the host adaptors allocates at least one host adaptor in the host to communicate with the switch to access the allocated storage space, and wherein the element managing the volume manager assigns the allocated storage space in the device to the requested logical volume used by the host.

36. The system of claim 35, wherein the system is capable of including multiple storage devices, switches, and host adaptors in the host, and wherein there is at least one separate element means to manage each storage device and switch in the system.

37. The system of claim 36, wherein the multiple element means further perform:
determining at least one switch and storage device in the system capable of supplying the storage and path resources to satisfy the user request, wherein the commands are communicated to the elements managing the determined switches and storage devices.

38. The system of claim 32, wherein each resource in the system is capable of being managed by multiple element means, wherein each of multiple element means for one resource performs the element operation in a different manner than other elements.

39. The system of claim 38, wherein there is an application program interface (API) set for each resource in the system, wherein the multiple element objects capable of managing one resource call the same API set to perform operations with respect to the managed resource.

40. The system of claim 32, wherein the commands are communicated by using element proxy objects registered with a lookup service.

41. An article of manufacture including code for managing multiple resources in a system by:
receiving a user request for an operation that requires performing separate element operations with respect to multiple resources in the system;
in response to the user request, communicating commands to multiple elements, wherein each element is capable of managing one of the resources in the system;
for each element receiving at least one of the communicated commands, performing:
(i) interpreting the received command;
(ii) performing the element operation requested by the received command with respect to the managed resource, wherein all the element operations performed by all the elements in response to receiving the commands implement the user requested operation.

42. The article of manufacture of claim 41, wherein the user requested operation comprises a request to allocate at least one resource in the system to a host in the system, and wherein the element operations requested by the received command comprise configuration operations to configure the managed resources to implement the user requested resource allocation.

43. The article of manufacture of claim 42, wherein the request to allocate the at least one system resource comprises a request to allocate additional storage space in the system to the host.

44. The article of manufacture of claim 43, wherein the request to allocate the at least one system resource includes a request to allocate the storage space to a logical volume in the host, wherein the resources managed by the elements comprise a storage device, a switch, a host adaptor, file system, and a volume manager, wherein the element managing the storage device allocates the storage space to the host, wherein the element managing the switch is capable of allocating at least one path in the switch to the storage device to allow the host to access the allocated storage space, wherein the element managing the host adaptors allocates at least one host adaptor in the host to communicate with the switch to access the allocated storage space, and wherein the element managing the volume manager assigns the allocated storage space in the device to the requested logical volume used by the host.

45. The article of manufacture of claim 44, wherein the system is capable of including multiple storage devices, switches, and host adaptors in the host, and wherein there is at least one separate element to manage each storage device and switch in the system.

46. The article of manufacture of claim 45, further comprising:
in response to the communicated commands, determining, with the elements, at least one switch and storage device in the system capable of supplying the storage and path resources to satisfy the user request, wherein the commands are communicated to the elements managing the determined switches and storage devices.

47. The article of manufacture of claim 41, wherein each resource in the system is capable of being managed by multiple elements, wherein each of multiple elements for one resource performs the element operation in a different manner than other elements.

48. The article of manufacture of claim 41, wherein there is an application program interface (API) set for each resource in the system, wherein the multiple element objects capable of managing one resource call the same API set to perform operations with respect to the managed resource.

49. The article of manufacture of claim 41, wherein the commands are communicated by using element proxy objects registered with a lookup service.

50. An article of manufacture including code for managing multiple resources in a system by:
registering a configuration service proxy object with a lookup service, wherein the configuration service proxy object includes code enabling access to a configuration service capable of configuring resources in the system;
registering configuration element proxy objects with the lookup service, wherein the configuration element proxy objects include code enabling access to element configurations that are capable of configuring system resources;
using the code in the configuration proxy object to communicate a user request for a configuration operation with respect to at least one system resource to the configuration service;
using, with the configuration service, the code in the configuration element proxy objects to communicate commands to the configuration elements to implement the requested configuration operations; and
in response to receiving the commands from the configuration service, performing, with the configuration elements, a configuration operation on the resource indicated in the received commands.

51. The article of manufacture of claim 50, wherein all the configuration operations performed by all the configuration elements in response to receiving commands from the configuration service implement the user requested configuration operation.

52. The article of manufacture of claim 50, wherein the user requested configuration operation comprises a request to allocate a resource in the system to a host in the system, and wherein the configuration operations performed by the configuration elements receiving the commands from the configuration service implement the user requested resource allocation.

53. The article of manufacture of claim 52, wherein the user requested resource allocation comprises a request to allocate additional storage space in the system to the host.

54. The article of manufacture of claim 50, wherein the request to allocate the at least one system resource includes a request to allocate the storage space to a logical volume in the host, wherein the resources managed by the configuration elements comprise a storage device, a switch, a host adaptor, file system, and a volume manager, wherein the configuration element managing the storage device allocates the storage space to the host, wherein the configuration element managing the switch is capable of allocating one or more paths in the switch to the storage device to allow the host to access the allocated storage space, wherein the configuration element managing the host adaptors is capable of allocating one or more host adaptors to access the allocated storage space through the switch, and wherein the configuration element managing the volume manager assigns the allocated storage space to the requested logical volume.

55. The article of manufacture of claim 50, wherein the system is capable of including multiple storage devices, switches, and host adaptors in the host, and wherein there is at least one separate configuration element to manage each storage device and switch in the system.

56 The article of manufacture of claim 55, further comprising:
in response to the user request, determining, with the configuration elements, at least one switch, storage device, and host adaptor in the system capable of supplying the storage and path resources to satisfy the user request, wherein the configuration elements configure the determined switches and storage devices.

57. The article of manufacture of claim 56, wherein the configuration elements query information on the system components to determine the system components capable of satisfying the user requested configuration operation.

58. The article of manufacture of claim 56, wherein configuration policy parameters are provided with each configuration element that specify how each configuration element configure the associated switch, storage device, or host adaptor.

59. The article of manufacture of claim 58, wherein the configuration policy parameters specify a level of availability to provide with the allocated storage space.

60. The article of manufacture of claim 54, wherein there are multiple configuration services calling different sets of elements to provide different qualities of configurations, further comprising:
selecting one of the configuration services.

61. The article of manufacture of claim 54, wherein the system is further capable of including backup programs and snapshot image programs, wherein there is at least one configuration element to manage each backup program and snapshot image program in each host.

62. The article of manufacture of claim 50, wherein each resource in the system is capable of being managed by multiple elements, wherein each of the multiple elements provided to configure one resource configure the resource differently.

63. The article of manufacture of claim 62, wherein there is an application program interface (API) proxy object for each resource in the system, wherein the multiple elements capable of configuring one resource use the same API proxy object to configure the associated resource.

64. The article of manufacture of claim 50, wherein the configuration service proxy object enables either remote or local access to the configuration service to configure capable of configuring resources in the system

65. A computer readable medium including data structures for managing multiple resources in a system, comprising:
a manager object including multiple commands that together implement a system operation with respect to multiple resources in the system; and
multiple element objects, wherein each element object is capable of managing one of the resources in the system, wherein the manager object communicates commands to multiple elements, wherein each element receiving at least one of the communicated commands interprets the received command and performs an element operation requested by the received command with respect to the managed resource, wherein all the element operations performed by all the elements in response to receiving the commands implement the requested system operation.

66. The computer readable medium of claim 65, wherein the system operation comprises a request to allocate at least one resource in the system to a host in the system, and wherein the element operations requested by the received command comprise configuration operations to configure the managed resources to implement the user requested resource allocation.

67. The computer readable medium of claim 65, wherein each resource in the system is capable of being managed by multiple elements, wherein each of the multiple elements that manage one resource performs the element operation in a different manner than other elements.

68. The computer readable medium of claim 67, wherein there is an application program interface (API) set for each resource in the system, wherein the multiple element objects capable of managing one resource call the same API set to perform operations with respect to the managed resource.

69. The computer readable medium of claim 65, wherein the manager object and element objects comprise proxy objects, further comprising:
a lookup service including registered instances of the manager proxy objects and element proxy objects, wherein the manager and element proxy objects include code enabling access to the operations performed by the proxy objects.
